(19) United States
(12) Patent Application Publication
(10) Pub. No.: US 2025/0267745 A1
(43) Pub. Date: Aug. 21, 2025

(54) METHOD AND APPARATUS FOR HANDLING PROTOCOL DATA UNIT SESSION ESTABLISHMENT IN WIRELESS COMMUNICATION SYSTEM

(71) Applicant: Samsung Electronics Co., Ltd., Suwon-si, Gyeonggi-do (KR)

(72) Inventors: Rajavelsamy RAJADURAI, Bangalore (IN); Rohini RAJENDRAN, Bangalore (IN); Nivedya Parambath SASI, Bangalore (IN)

(21) Appl. No.: 18/856,484

(22) PCT Filed: Apr. 12, 2023
(86) PCT No.: PCT/KR2023/004962

§ 371 Date: Oct. 11, 2024

(30) Foreign Application Priority Data
Apr. 12, 2022 (IN) 202241021999
Mar. 31, 2023 (IN) 2022 41021999

(51) Int. Cl. H04W 76/18; H04L 67/142

(52) U.S. Cl. CPC H04W 76/18; H04L 67/142

(57) ABSTRACT

The disclosure relates to a 5G or 6G communication system for supporting a higher data transmission rate. The method includes receiving, by a network apparatus (100), a PDU session establishment request message from a UE (200) to establish a plurality of PDU sessions, determining whether all the plurality of PDU sessions are activated or at least one PDU session is rejected by the network apparatus (100). Further, the method includes sending a PDU session establishment accept message including an indication indicating partial PDU session establishment when the at least one PDU sessions is activated or a PDU session establishment accept message including an indication indicating complete PDU session establishment to the UE (200) when all the plurality of PDU sessions are activated. Furthermore the method includes sending a PDU session reject message to the UE (200), when at least one PDU session is rejected by the network apparatus (100).

### TECHNICAL FIELD

The present disclosure relates to wireless communication. More particularly, the disclosure relates to handling Protocol Data Unit (PDU) session establishment in a wireless network.

### BACKGROUND ART

5G mobile communication technologies define broad frequency bands such that high transmission rates and new services are possible, and can be implemented not only in “Sub 6 GHz” bands such as 3.5 GHz, but also in “Above 6 GHz” bands referred to as mmWave including 28 GHz and 39 GHz. In addition, it has been considered to implement 6G mobile communication technologies (referred to as Beyond 5G systems) in terahertz (THz) bands (for example, 95 GHz to 3 THz bands) in order to accomplish transmission rates fifty times faster than 5G mobile communication technologies and ultra-low latencies one-tenth of 5G mobile communication technologies.

At the beginning of the development of 5G mobile communication technologies, in order to support services and to satisfy performance requirements in connection with enhanced Mobile BroadBand (eMBB), Ultra Reliable Low Latency Communications (URLLC), and massive Machine-Type Communications (mMTC), there has been ongoing standardization regarding beamforming and massive MIMO for mitigating radio-wave path loss and increasing radio-wave transmission distances in mmWave, supporting numerologies (for example, operating multiple subcarrier spacings) for efficiently utilizing mmWave resources and dynamic operation of slot formats, initial access technologies for supporting multi-beam transmission and broadbands, definition and operation of BWP (BandWidth Part), new channel coding methods such as a LDPC (Low Density Parity Check) code for large amount of data transmission and a polar code for highly reliable transmission of control information, L2 pre-processing, and network slicing for providing a dedicated network specialized to a specific service.

Currently, there are ongoing discussions regarding improvement and performance enhancement of initial 5G mobile communication technologies in view of services to be supported by 5G mobile communication technologies, and there has been physical layer standardization regarding technologies such as V2X (Vehicle-to-everything) for aiding driving determination by autonomous vehicles based on information regarding positions and states of vehicles transmitted by the vehicles and for enhancing user convenience, NR-U (New Radio Unlicensed) aimed at system operations conforming to various regulation-related requirements in unlicensed bands, NR UE Power Saving, Non-Terrestrial Network (NTN) which is UE-satellite direct communication for providing coverage in an area in which communication with terrestrial networks is unavailable, and positioning.

Moreover, there has been ongoing standardization in air interface architecture/protocol regarding technologies such as Industrial Internet of Things (IIoT) for supporting new services through interworking and convergence with other industries, IAB (Integrated Access and Backhaul) for providing a node for network service area expansion by supporting a wireless backhaul link and an access link in an integrated manner, mobility enhancement including conditional handover and DAPS (Dual Active Protocol Stack) handover, and two-step random access for simplifying random access procedures (2-step RACH for NR). There also has been ongoing standardization in system architecture/service regarding a 5G baseline architecture (for example, service based architecture or service based interface) for combining Network Functions Virtualization (NFV) and Software-Defined Networking (SDN) technologies, and Mobile Edge Computing (MEC) for receiving services based on UE positions.

As 5G mobile communication systems are commercialized, connected devices that have been exponentially increasing will be connected to communication networks, and it is accordingly expected that enhanced functions and performances of 5G mobile communication systems and integrated operations of connected devices will be necessary. To this end, new research is scheduled in connection with extended Reality (XR) for efficiently supporting AR (Augmented Reality), VR (Virtual Reality), MR (Mixed Reality) and the like, 5G performance improvement and complexity reduction by utilizing Artificial Intelligence (AI) and Machine Learning (ML), AI service support, metaverse service support, and drone communication.

Furthermore, such development of 5G mobile communication systems will serve as a basis for developing not only new waveforms for providing coverage in terahertz bands of 6G mobile communication technologies, multi-antenna transmission technologies such as Full Dimensional MIMO (FD-MIMO), array antennas and large-scale antennas, metamaterial-based lenses and antennas for improving coverage of terahertz band signals, high-dimensional space multiplexing technology using OAM (Orbital Angular Momentum), and RIS (Reconfigurable Intelligent Surface), but also full-duplex technology for increasing frequency efficiency of 6G mobile communication technologies and improving system networks, AI-based communication technology for implementing system optimization by utilizing satellites and AI (Artificial Intelligence) from the design stage and internalizing end-to-end AI support functions, and next-generation distributed computing technology for implementing services at levels of complexity exceeding the limit of UE operation capability by utilizing ultrahigh-performance communication and computing resources.

### DISCLOSURE OF INVENTION

### Solution to Problem

This disclosure relates to wireless communication networks, and more particularly to a terminal and a communication method thereof in a wireless communication system.

In an embodiment, the PDU session establishment request message includes a Single-Network Slice Selection Assistance Information (S-NSSAI), a UE requested Data Network Name (DNN), a Subscriber Permanent Identifier (SUPI), a PDU session Identifier (ID), a request type, and a PDU session establishment request comprising a plurality of PDU sessions attributes.

### Advantageous Effects of Invention

Aspects of the disclosure are to address at least the above-mentioned problems and/or disadvantages and to provide at least the advantages described below. Accordingly, an aspect of the disclosure is to provide efficient communication methods in a wireless communication system.

### BRIEF DESCRIPTION OF DRAWINGS

This invention is illustrated in the accompanying drawings, throughout which like reference letters indicate corresponding parts in the various figures. The embodiments herein will be better understood from the following description with reference to the drawings, in which:

FIG. 1 is a block diagram of a network apparatus for handling PDU session establishment in a wireless network, according to the embodiments as disclosed herein;

FIG. 2 is a block diagram of a UE for handling PDU session establishment in the wireless network, according to the embodiments as disclosed herein;

FIG. 3 is a flow chart illustrating a method for handling PDU session establishment in the wireless network by the network apparatus, according to the embodiments as disclosed herein;

FIG. 4 is a flow chart illustrating a method for handling PDU session establishment in the wireless network by the UE, according to the embodiments as disclosed herein;

FIG. 5 is an example illustrating a step-by step procedure for handling PDU session establishment in the wireless network, according to the embodiments as disclosed herein;

FIG. 6 is an example illustrating a step-by step procedure for activation of all PDU sessions together or one by one per DNN and S-NSSAI/Data Radio Bearers (DRB) approach, according to the embodiments as disclosed herein; and

FIG. 7 is an example illustrating a step-by step procedure for determining a need for a plurality of PDU sessions establishment and initiating PDU sessions for other DRBs with different security policies, according to the embodiments as disclosed herein.

FIG. 8 illustrates various hardware components of a network entity, according to the embodiments as disclosed herein.

FIG. 9 illustrates a structure of a base station according to an embodiment of the disclosure.

FIG. 10 illustrates a structure of a UE according to an embodiment of the disclosure.

Throughout the drawings, it should be noted that like reference numbers are used to depict the same or similar elements, features, and structures.

### BEST MODE FOR CARRYING OUT THE INVENTION

Aspects of the disclosure are to address at least the above-mentioned problems and/or disadvantages and to provide at least the advantages described below. Accordingly, an aspect of the disclosure is to provide a terminal and a communication method thereof in a wireless communication system.

Accordingly the embodiments herein disclose a method for handling PDU session establishment in a wireless network. The method includes receiving, by a network apparatus, a PDU session establishment request message from a UE to establish a plurality of PDU sessions. The method includes determining whether all the plurality of PDU sessions are activated by the network apparatus or at least one PDU session of the plurality of PDU sessions is rejected by the network apparatus. The method includes performing one of: (i) sending a PDU session establishment accept message including an indication which indicates partial PDU session establishment to the UE, when at least one PDU session of the plurality of PDU sessions is requested by the network apparatus, (ii) sending a PDU session establishment accept message including an indication which indicates complete PDU session establishment to the UE, when all the plurality of PDU sessions are activated by the network apparatus, and (iii) sending a PDU session reject message to the UE, when at least one PDU session of the plurality of PDU sessions is rejected by the network apparatus.

In an embodiment, the PDU session establishment request message includes a Single-Network Slice Selection Assistance Information (S-NSSAI), a UE requested Data Network Name (DNN), a Subscriber Permanent Identifier (SUPI), a PDU session Identifier (ID), a request type, and a PDU session establishment request comprising a plurality of PDU sessions attributes.

In an embodiment, the plurality of PDU sessions attributes of the PDU session establishment request includes at least one of the PDU session ID, a requested PDU session type, a multi-access PDU connectivity service indicating when the at least one PDU session provides multi-access PDU connectivity service or not, and a flag bit to determine number of PDU sessions or the plurality of PDU sessions to be established per DNN and S-NSSAI based on different security policies.

In an embodiment, determining, by the network apparatus, whether all the plurality of PDU sessions are activated by the network apparatus or at least one PDU session of the plurality of PDU sessions is rejected by the network apparatus includes: determining whether the plurality of PDU sessions needs to be established based on the PDU session establishment request message; determining the PDU session ID and status of the plurality of PDU sessions from one of the plurality of PDU sessions attributes, session management subscription data or based on local/network/operator's configuration indicating number of PDU sessions to be established and security policy for each PDU session of the plurality of PDU sessions, when the plurality of PDU sessions needs to be established; recording the PDU session ID and the status of the plurality of PDU sessions in a Session Management (SM) context; and determining whether all the plurality of PDU sessions are activated by the network apparatus or at least one PDU session is rejected by the network apparatus based on the SM context.

In an embodiment, when the session management subscription data for corresponding SUPI, DNN and S-NSSAI is not available, retrieving, by the network apparatus, the session management subscription data from an Unified Data Management (UDM) indicating a need for the plurality of PDU sessions establishment, sending, by the network apparatus, an update request to receive an update notification on the retrieved session management subscription data to the UDM, and determining, by the network apparatus, the PDU session ID, the assigned IP address and the status of the plurality of PDU sessions upon the receiving the update notification on the retrieved session management subscription data from the UDM.

In an embodiment, the update notification includes allowed PDU session types, a default PDU session type, Quality of service (QOS) information per DNN and per S-NSSAI, and a plurality of PDU sessions indication for the DNN and the S-NSSAI with different subscribed User Plane (UP) security policies.

In an embodiment, sending, by the network apparatus, the PDU session establishment accept message including the indication which indicates the complete PDU session establishment includes: determining whether the PDU session establishment request includes a required number of PUD sessions, and performing one of: (i) sending the PDU session establishment accept message includes the indication indicating the complete PDU session establishment by accepting all the plurality of PDU sessions together when the PDU establishment request includes the required number of the PUD sessions, and (ii) separately sending the PDU session establishment accept message including the indication indicating the complete PDU session establishment for each PDU session when the PDU establishment request does not includes the required number of the PUD sessions.

In an embodiment, sending, by the UE, the PDU session establishment request message to the network apparatus to establish a plurality of PDU sessions includes: receiving the PDU session establishment accept message including one of the indication indicating partial PDU session establishment from the network apparatus and the indication indicating complete PDU session establishment from the network apparatus, and performing one of: (i) holding transfer of data to the network apparatus when the PDU session establishment accept message includes the indication indicating the partial PDU session establishment is received by the UE, and (ii) configuring the plurality of PDU sessions and starting transfer of the data to the network apparatus when the PDU session establishment accept message includes the indication indicating complete PDU session establishment is received by the UE.

In an embodiment, the UE receives the PDU session establishment accept message includes the indication indicating the partial PDU session establishment when at least one PDU session of the plurality of PDU sessions is requested by the network apparatus.

In an embodiment, the UE receives the PDU session establishment accept message including the indication indicating the complete PDU session establishment when all the plurality of PDU sessions are activated by the network apparatus.

In an embodiment, the UE receives the PDU session reject message from the network apparatus, when at least one PDU session of the plurality of PDU sessions is rejected by the network apparatus.

In an embodiment, the UE holds the transfer of the data to the network apparatus until all the plurality of PDU sessions are established and initiates a new PDU session establishment request for establishing remaining PDU sessions of the plurality of PDU sessions.

In an embodiment, the method includes sending, by the UE, the new PDU session establishment request to establish the remaining PDU sessions from the plurality of PDU sessions to the network apparatus. The method includes determining, by the network apparatus, whether all the remaining PDU sessions are activated by the network apparatus or at least one remaining PDU session is rejected by the network apparatus. The method includes performing, by the UE, one of: (i) receiving a new PDU session establishment accept message including the indication indicating partial PDU session establishment from the network apparatus, when at least one remaining PDU session of the plurality of PDU sessions is activated by the network apparatus, (ii) receiving a new PDU session establishment accept message including the indication indicating complete PDU session establishment from the network apparatus, when all the remaining PDU sessions are activated by the network apparatus, and receiving a new PDU session reject message from the network apparatus, when at least one remaining PDU session of the plurality of PDU sessions is rejected by the network apparatus.

In an embodiment, the new PDU session establishment request includes a PDU session ID, a requested PDU session type, a UE integrity protection maximum data rate, a RSN, a PDU session pair ID, a SSC mode, a UP security enforcement information, a multi-access PDU connectivity service indicating when the at least one remaining PDU session provides multi-access PDU connectivity service or not, and a flag bit to determine number of PDU sessions or the remaining PDU sessions to be established per DNN, S-NSSAI based on different security policies.

Accordingly the embodiments herein disclose the network apparatus for handling PDU session establishment in the wireless network. The network apparatus includes a memory, a processor coupled with the memory, a communicator coupled with the memory and the processor, and a PDU session management controller coupled with the memory, the processor and the communicator. The PDU session management controller configured to receive the PDU session establishment request message from the UE to establish the plurality of PDU sessions, determine whether all the plurality of PDU sessions are activated by the network apparatus or at least one PDU session of the plurality of PDU sessions is rejected by the network apparatus, and perform one of: (i) send the PDU session establishment accept message including the indication indicating the partial PDU session establishment to the UE, when at least one PDU session of the plurality of PDU sessions is requested by the network apparatus, (ii) send the PDU session establishment accept message including the indication indicating complete PDU session establishment to the UE, when all the plurality of PDU sessions are activated by the network apparatus, and (iii) send the PDU session reject message to the UE, when at least one PDU session of the plurality of PDU sessions is rejected by the network apparatus.

Accordingly the embodiments herein disclose the UE for handling PDU session establishment in the wireless network. The UE includes a memory, a processor coupled with the memory, a communicator coupled with the memory and the processor, and a PDU session establishment controller coupled with the memory, the processor and the communicator. The PDU session establishment controller configured to send the PDU session establishment request message to the network apparatus to establish the plurality of PDU sessions, receive the PDU session establishment accept message including one of the indication indicating the partial PDU session establishment from the network apparatus and the indication indicating the complete PDU session establishment from the network apparatus, and perform one of: (i) hold transfer of data to the network apparatus when the PDU session establishment accept message includes the indication indicating the partial PDU session establishment is received by the UE, and (ii) configure the plurality of PDU sessions and start transfer of the data to the network apparatus when the PDU session establishment accept message includes the indication indicating the complete PDU session establishment is received by the UE.

These and other aspects of the embodiments herein will be better appreciated and understood when considered in conjunction with the following description and the accompanying drawings. It should be understood that the following descriptions, while indicating preferred embodiments and numerous specific details thereof, are given by way of illustration and not of limitation. Many changes and modifications may be made within the scope of the embodiments herein without departing from the invention thereof, and the embodiments herein include all such modifications.

### MODE FOR THE INVENTION

The following description with reference to the accompanying drawings is provided to assist in a comprehensive understanding of various embodiments of the disclosure as defined by the claims and their equivalents. It includes various specific details to assist in that understanding but these are to be regarded as merely exemplary. Accordingly, those of ordinary skill in the art will recognize that various changes and modifications of the various embodiments described herein can be made without departing from the scope and spirit of the disclosure. In addition, descriptions of well-known functions and constructions may be omitted for clarity and conciseness.

The terms and words used in the following description and claims are not limited to their bibliographical meanings, but, are merely used by the inventor to enable a clear and consistent understanding of the disclosure. Accordingly, it should be apparent to those skilled in the art that the following description of various embodiments of the disclosure is provided for illustration purpose only and not for the purpose of limiting the disclosure as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

Before undertaking the DETAILED DESCRIPTION below, it can be advantageous to set forth definitions of certain words and phrases used throughout this patent document. The term “couple” and its derivatives refer to any direct or indirect communication between two or more elements, whether or not those elements are in physical contact with one another. The terms “transmit,” “receive,” and “communicate,” as well as derivatives thereof, encompass both direct and indirect communication. The terms “include” and “comprise,” as well as derivatives thereof, mean inclusion without limitation. The term “or” is inclusive, meaning and/or. The phrase “associated with,” as well as derivatives thereof, means to include, be included within, connect to, interconnect with, contain, be contained within, connect to or with, couple to or with, be communicable with, cooperate with, interleave, juxtapose, be proximate to, be bound to or with, have, have a property of, have a relationship to or with, or the like. The term “controller” means any device, system or part thereof that controls at least one operation. Such a controller can be implemented in hardware or a combination of hardware and software and/or firmware. The functionality associated with any particular controller can be centralized or distributed, whether locally or remotely. The phrase “at least one of,” when used with a list of items, means that different combinations of one or more of the listed items can be used, and only one item in the list can be needed. For example, “at least one of: A, B, and C” includes any of the following combinations: A, B, C, A and B, A and C, B and C, and A and B and C. For example, “at least one of: A, B, or C” includes any of the following combinations: A, B, C, A and B, A and C, B and C, and A, B and C.

Moreover, various functions described below can be implemented or supported by one or more computer programs, each of which is formed from computer-readable program code and embodied in a computer-readable medium. The terms “application” and “program” refer to one or more computer programs, software components, sets of instructions, procedures, functions, objects, classes, instances, related data, or a portion thereof adapted for implementation in a suitable computer-readable program code. The phrase “computer-readable program code” includes any type of computer code, including source code, object code, and executable code. The phrase “computer-readable medium” includes any type of medium capable of being accessed by a computer, such as Read-Only Memory (ROM), Random Access Memory (RAM), a hard disk drive, a Compact Disc (CD), a Digital Video Disc (DVD), or any other type of memory. A “non-transitory” computer-readable medium excludes wired, wireless, optical, or other communication links that transport transitory electrical or other signals. A non-transitory computer-readable medium includes media where data can be permanently stored and media where data can be stored and later overwritten, such as a rewritable optical disc or an erasable memory device.

Terms used herein to describe the embodiments of the disclosure are not intended to limit and/or define the scope of the disclosure. For example, unless otherwise defined, the technical terms or scientific terms used in the disclosure shall have the ordinary meaning understood by those with ordinary skills in the art to which the disclosure belongs.

It should be understood that “first”, “second” and similar words used in the disclosure do not express any order, quantity or importance, but are only used to distinguish different components.

As used herein, any reference to “an example” or “example”, “an implementation” or “implementation”, “an embodiment” or “embodiment” means that particular elements, features, structures or characteristics described in connection with the embodiment is included in at least one embodiment. The phrases “in one embodiment” or “in one example” appearing in different places in the specification do not necessarily refer to the same embodiment.

As used herein, “a portion of” something means “at least some of” the thing, and as such may mean less than all of, or all of, the thing. As such, “a portion of” a thing includes the entire thing as a special case, i.e., the entire thing is an example of a portion of the thing.

As used herein, the term “set” means one or more. Accordingly, a set of items can be a single item or a collection of two or more items.

In this disclosure, to determine whether a specific condition is satisfied or fulfilled, expressions, such as “greater than” or “less than” are used by way of example and expressions, such as “greater than or equal to” or “less than or equal to” are also applicable and not excluded. For example, a condition defined with “greater than or equal to” may be replaced by “greater than” (or vice-versa), a condition defined with “less than or equal to” may be replaced by “less than” (or vice-versa), etc.

It will be further understood that similar words such as the term “include” or “comprise” mean that elements or objects appearing before the word encompass the listed elements or objects appearing after the word and their equivalents, but other elements or objects are not excluded. Similar words such as “connect” or “connected” are not limited to physical or mechanical connection, but can include electrical connection, whether direct or indirect. “Upper”, “lower”, “left” and “right” are only used to express a relative positional relationship, and when an absolute position of the described object changes, the relative positional relationship may change accordingly.

Those skilled in the art will understand that the principles of the disclosure can be implemented in any suitably arranged wireless communication system. For example, although the following detailed description of the embodiments of the disclosure will be directed to LTE and/or 5G communication systems, those skilled in the art will understand that the main points of the disclosure can also be applied to other communication systems with similar technical backgrounds and channel formats with slight modifications without departing from the scope of the disclosure. The technical schemes of the embodiments of the application can be applied to various communication systems, and for example, the communication systems may include global systems for mobile communications (GSM), code division multiple access (CDMA) systems, wideband code division multiple access (WCDMA) systems, general packet radio service (GPRS) systems, long term evolution (LTE) systems, LTE frequency division duplex (FDD) systems, LTE time division duplex (TDD) systems, universal mobile telecommunications system (UMTS), worldwide interoperability for microwave access (WiMAX) communication systems, 5th generation (5G) systems or new radio (NR) systems, etc. In addition, the technical schemes of the embodiments of the application can be applied to future-oriented communication technologies. In addition, the technical schemes of the embodiments of the application can be applied to future-oriented communication technologies.

In order to meet the increasing demand for wireless data communication services since the deployment of 4G communication systems, efforts have been made to develop improved 5G or pre-5G communication systems. Therefore, 5G or pre-5G communication systems are also called “Beyond 4G networks” or “Post-LTE systems”.

In Fifth-Generation (5G), integrity protection of a user plane (UP) between a user device and a base station is adopted to ensure secure communication. Like an encryption feature, support of an integrity protection feature is needed on both the user device and the base station while use is optional and under control of an operator. Currently, User Plane Integrity Protection (UPIP) is optional to be activated at a Packet Data Convergence Protocol (PDCP) layer and a need to activate the UPIP is determined by a network apparatus. When the network apparatus determines that the UPIP is not required based on local policy/configuration, then either one of the following inefficient and/or ineffective actions is performed:
The UPIP is activated for an entire Protocol Data Unit (PDU) session, based on a mandated requirement to apply UPIP for some of the application layer signaling traffics, leading to redundant cryptographic computations and energy inefficiency.
The UPIP is deactivated for the entire PDU session, resulting in exchange of the application layer signaling traffics without protection. This leads to downgrading a security level.

5G Multicast and Broadcast Service (MBS) security provides flexibility to enhance an UP security mechanism to support emerging 5G vertical deployments, but fails to protect MBS traffic at the PDCP layer, as security is handled at an upper layer. Similarly, such flexibility is required for other verticals, for example extended Reality (XR) application to avoid redundant UPIP at multiple layers. As MBS which is a downlink multicast and broadcast traffic delivery, relaxation of the UP security of applications, for example XR application and Cloud Gaming having both uplink and downlink unicast traffic delivery is not possible, as these applications exchange critical and/or sensitive application layer messages which need protection, whereas the MBS traffic may not need protection.

Conventionally, when the network apparatus configures a User Equipment (UE) to establish a plurality of PDU sessions for example, two PDU sessions for a requested Data Network Name (DNN) and a Single-Network Slice Selection Assistance Information (S-NSSAI) combination, one PDU session is established to communicate sensitive traffic for which UPIP is activated and other PDU sessions are established for Quality of service (QOS) sensitive communication for which UPIP is not activated. When the UE is limited to establish only one PDU session, then the UE requests the first PDU session and does not request a second PDU session for the DNN and the S-NSSAI combination. In such scenario, either all traffics of the application is communicated via the first PDU session, resulting in redundant UPIP at multiple layers, or all traffics of the application is communicated via the second PDU session, resulting in downgrading the security level.

Thus, there is a need to enhance the UP security mechanism to support the emerging verticals and requirements to enhance system's performance while providing more flexibility by addressing the above mentioned disadvantages or other shortcomings or at least providing a useful alternative.

The principal object of the embodiments herein is to provide a method and a system for handling PDU session establishment in a wireless network. The method includes determining whether all the plurality of PDU sessions are activated by the network apparatus or at least one PDU session of the plurality of PDU sessions is rejected by the network apparatus.

Another object of the embodiments herein is to send a PDU session establishment accept message with an indication indicating partial PDU session establishment to the UE when at least one PDU session of the plurality of PDU sessions is requested, or send the PDU session establishment accept message with an indication indicating complete PDU session establishment to the UE when all the plurality of PDU sessions are activated by the network apparatus, or send a PDU session reject message to the UE when at least one PDU session of the plurality of PDU sessions is rejected by the network apparatus.

Yet another object of the embodiments herein is to provide the network apparatus that determines UP security policy for each PDU session separately based on a requested PDU session establishment and establishes the plurality of PDU sessions securely. The proposed method establishes the plurality of PDU sessions for DNN and S-NSSAI combination with different security policies per PDU session to mitigate security issues.

Accordingly the embodiments herein disclose a method for handling PDU session establishment in a wireless network. The method includes receiving, by a network apparatus, a PDU session establishment request message from a UE to establish a plurality of PDU sessions. The method includes determining whether all the plurality of PDU sessions are activated by the network apparatus or at least one PDU session of the plurality of PDU sessions is rejected by the network apparatus. The method includes performing one of: (i) sending a PDU session establishment accept message including an indication which indicates partial PDU session establishment to the UE, when at least one PDU session of the plurality of PDU sessions is requested by the network apparatus, (ii) sending a PDU session establishment accept message including an indication which indicates complete PDU session establishment to the UE, when all the plurality of PDU sessions are activated by the network apparatus, and (iii) sending a PDU session reject message to the UE, when at least one PDU session of the plurality of PDU sessions is rejected by the network apparatus.

Accordingly the embodiments herein disclose the network apparatus for handling PDU session establishment in the wireless network. The network apparatus includes a memory, a processor coupled with the memory, a communicator coupled with the memory and the processor, and a PDU session management controller coupled with the memory, the processor and the communicator. The PDU session management controller configured to receive the PDU session establishment request message from the UE to establish the plurality of PDU sessions, determine whether all the plurality of PDU sessions are activated by the network apparatus or at least one PDU session of the plurality of PDU sessions is rejected by the network apparatus, and perform one of: (i) send the PDU session establishment accept message including the indication indicating the partial PDU session establishment to the UE, when at least one PDU session of the plurality of PDU sessions is requested by the network apparatus, (ii) send the PDU session establishment accept message including the indication indicating complete PDU session establishment to the UE, when all the plurality of PDU sessions are activated by the network apparatus, and (iii) send the PDU session reject message to the UE, when at least one PDU session of the plurality of PDU sessions is rejected by the network apparatus.

Accordingly the embodiments herein disclose the UE for handling PDU session establishment in the wireless network. The UE includes a memory, a processor coupled with the memory, a communicator coupled with the memory and the processor, and a PDU session establishment controller coupled with the memory, the processor and the communicator. The PDU session establishment controller configured to send the PDU session establishment request message to the network apparatus to establish the plurality of PDU sessions, receive the PDU session establishment accept message including one of the indication indicating the partial PDU session establishment from the network apparatus and the indication indicating the complete PDU session establishment from the network apparatus, and perform one of: (i) hold transfer of data to the network apparatus when the PDU session establishment accept message includes the indication indicating the partial PDU session establishment is received by the UE, and (ii) configure the plurality of PDU sessions and start transfer of the data to the network apparatus when the PDU session establishment accept message includes the indication indicating the complete PDU session establishment is received by the UE.

In conventional methods and systems, when the security is activated at a PDCP layer for protection of an application layer signaling traffic then streaming traffic is also protected at the PDCP layer. Once the security is activated, the conventional methods and systems has no provision to deactivate the protection of the streaming traffic at the PDCP layer, even though the streaming traffic is protected at the application layer. The application layer signaling traffic for example, Internet Control Message Protocol (ICMP) requires protection at the PDCP layer, which enforces protection of all other traffics carried by the same PDU session. In such cases, features of the applications which include but not limited to an extended Reality (XR) application, a cloud gaming application and an Ultra Reliable Low Latency Communication (URLLC) applications are affected. The features include but not limited to high-speed packetization and energy efficiency communication. To scale these applications, security need to be activated or deactivated with finer granularity and not for the whole PDU session.

In conventional methods and systems, as UP security policy from the network apparatus is applied for the entire PDU session, granular activation or deactivation of the security for a particular traffic within the PDU session is not supported. When activation of the security is required for the particular traffic at the PDCP layer, all traffics over that PDU session should be protected, which is an overhead, and that affects Quality of Experience (QoE) for Quality of Service (QOS) sensitive traffic due to redundant cryptographic determination and leads to energy inefficiency.

Unlike the conventional methods and systems, the proposed method performs secure establishment of the plurality of PDU sessions for selective protection on the PDU sessions per Data Network Name (DNN) and Single-Network Slice Selection Assistance Information (S-NSSAI) combination. Thereby, enhancing a UP security mechanism to support emerging 5G vertical deployments and requirements to enrich a system performance, while providing more flexibility without lowering the security level. The UE is pre-configured with security information to initiate the plurality of PDU sessions for the DNN and the S-NSSAI. The configuration information is provided by the network apparatus to the UE, for example using at least one of following mechanisms: as part of application configuration, as part of User Equipment Route Selection Policy (URSP), and as part of Universal Subscriber Identity Module (USIM) configuration. The UE determines whether all the plurality of PDU sessions are activated by the network apparatus or at least one PDU session of the plurality of PDU sessions is rejected by the network apparatus independently. Based on the requested PDU session establishment, the network apparatus determines UP security policy for each PDU session independently.

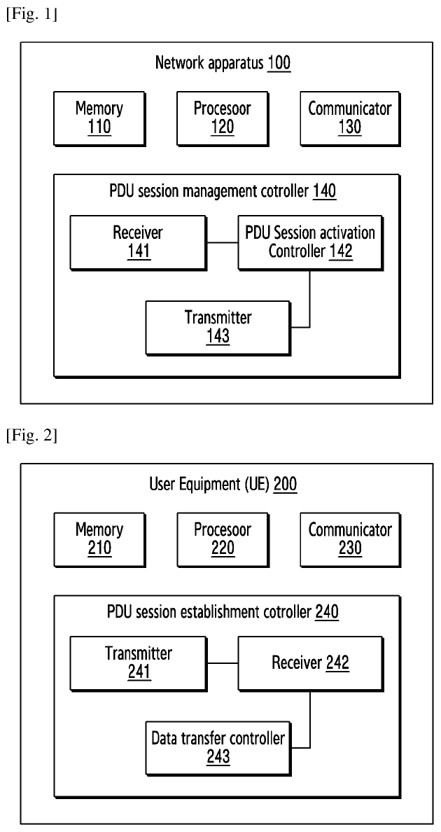

Referring now to the drawings and more particularly to FIGS. 1 through 7, where similar reference characters denote corresponding features consistently throughout the figure, these are shown preferred embodiments.

FIG. 1 is a block diagram of a network apparatus (100) for handling PDU session establishment in a wireless network, according to the embodiments as disclosed herein. Referring to the FIG. 1, the network apparatus (100) include but not limited to a Session Management Function (SMF) device and an Access and Mobility Management Function (AMF) device.

In an embodiment, the network apparatus (100) includes a memory (110), a processor (120), a communicator (130), and a PDU session management controller (140). However, the components of the network apparatus (100) are not limited thereto. For example, the network apparatus (100) may include more or fewer components than those described above. In addition, the network apparatus (100) corresponds to the network entity of the FIG. 8.

The memory (110) is configured to store a DNN, a S-NSSAI, a PDU session ID, a requested PDU session type, and a UE Integrity Protection Maximum Data Rate included in the PDU session establishment request message. The memory (110) can include non-volatile storage elements. Examples of such non-volatile storage elements may include magnetic hard discs, optical discs, floppy discs, flash memories, or forms of electrically programmable memories (EPROM) or electrically erasable and programmable (EEPROM) memories. In addition, the memory (110) may, in some examples, be considered a non-transitory storage medium. The term “non-transitory” may indicate that the storage medium is not embodied in a carrier wave or a propagated signal. The term “non-transitory” should not be interpreted that the memory (110) is non-movable. In some examples, the memory (110) is configured to store larger amounts of information. In certain examples, a non-transitory storage medium may store data that can, over time, change (e.g., in Random Access Memory (RAM) or cache).

The processor (120) may include one or a plurality of processors. The one or the plurality of processors may be a general-purpose processor, such as a central processing unit (CPU), an application processor (AP), or the like, a graphics-only processing unit such as a graphics processing unit (GPU), a visual processing unit (VPU), and/or an AI-dedicated processor such as a neural processing unit (NPU). The processor (120) may include multiple cores and is configured to determine the DNN, the S-NSSAI, the PDU session ID, the requested PDU session type, and the UE Integrity Protection Maximum Data Rate stored in the memory (110).

In an embodiment, the communicator (130) includes an electronic circuit specific to a standard that enables wired or wireless communication. The communicator (130) is configured to communicate internally between internal hardware components of the network apparatus (100) and with external devices via one or more networks.

In an embodiment, the PDU session management controller (140) includes a receiver (141), a PDU session activation controller (142) and a transmitter (143).

In an embodiment, the receiver (141) is configured to receive a PDU session establishment request message from a UE to establish a plurality of PDU sessions. The PDU session establishment request message includes but not limited to the S-NSSAI, a DNN requested by the UE, a SUPI, the PDU session ID, a request type, and a PDU session establishment request comprising a plurality of PDU sessions attributes.

In an embodiment, the plurality of PDU sessions attributes of the PDU session establishment request includes but not limited to the PDU session ID, a requested PDU session type, a multi-access PDU connectivity service indicating when the at least one PDU session provides multi-access PDU connectivity service or not, and a flag bit to determine number of PDU sessions or the plurality of PDU sessions to be established per DNN and S-NSSAI based on different security policies.

In an embodiment, the PDU session activation controller (142) is configured to determine whether all the plurality of PDU sessions are activated by the network apparatus (100) or at least one PDU session of the plurality of PDU sessions is rejected by the network apparatus (100).

In an embodiment, the transmitter (143) is configured to perform one of:
send a PDU session establishment accept message including an indication which indicates partial PDU session establishment to the UE, when at least one PDU session of the plurality of PDU sessions is requested by the network apparatus (100),
send a PDU session establishment accept message including an indication which indicates complete PDU session establishment to the UE, when all the plurality of PDU sessions are activated by the network apparatus (100), or
send a PDU session reject message to the UE, when at least one PDU session of the plurality of PDU sessions is rejected by the network apparatus.

The PDU session management controller (140) is implemented by processing circuitry such as logic gates, integrated circuits, microprocessors, microcontrollers, memory circuits, passive electronic components, active electronic components, optical components, hardwired circuits, or the like, and may optionally be driven by firmware. The circuits may, for example, be embodied in one or more semiconductor chips, or on substrate supports such as printed circuit boards and the like.

At least one of the plurality of modules/components of the PDU session management controller (140) may be implemented through an AI model. A function associated with the AI model may be performed through memory (110) and the processor (120). The one or a plurality of processors controls the processing of the input data in accordance with a predefined operating rule or the AI model stored in the non-volatile memory and the volatile memory. The predefined operating rule or artificial intelligence model is provided through training or learning.

Here, being provided through learning means that, by applying a learning process to a plurality of learning data, a predefined operating rule or AI model of a desired characteristic is made. The learning may be performed in a device itself in which AI according to an embodiment is performed, and/or may be implemented through a separate server/system.

The AI model can include of a plurality of neural network layers. Each layer has a plurality of weight values and performs a layer operation through calculation of a previous layer and an operation of a plurality of weights. Examples of neural networks include, but are not limited to, convolutional neural network (CNN), deep neural network (DNN), recurrent neural network (RNN), restricted Boltzmann Machine (RBM), deep belief network (DBN), bidirectional recurrent deep neural network (BRDNN), generative adversarial networks (GAN), and deep Q-networks.

The learning process is a method for training a predetermined target device (for example, a robot) using a plurality of learning data to cause, allow, or control the target device to make a determination or prediction. Examples of learning processes include, but are not limited to, supervised learning, unsupervised learning, semi-supervised learning, or reinforcement learning.

FIG. 2 is a block diagram of the UE (200) for handling PDU session establishment in the wireless network, according to the embodiments as disclosed herein. Referring to the FIG. 2, the UE (200) may be but not limited to a laptop, a palmtop, a desktop, a mobile phone, a smart phone, Personal Digital Assistant (PDA), a tablet, a wearable device, an Internet of Things (IoT) device, a virtual reality device, a foldable device, a flexible device, a display device and an immersive system.

In an embodiment, the UE (200) includes a memory (210), a processor (220), a communicator (230), and a PDU session establishment controller (240).

The memory (210) is configured to store the DNN, the S-NSSAI, the PDU session ID, the requested PDU session type, and the UE Integrity Protection Maximum Data Rate included in the PDU session establishment request message. The memory (210) can include non-volatile storage elements. Examples of such non-volatile storage elements may include magnetic hard discs, optical discs, floppy discs, flash memories, or forms of electrically programmable memories (EPROM) or electrically erasable and programmable (EEPROM) memories. In addition, the memory (210) may, in some examples, be considered a non-transitory storage medium. The term “non-transitory” may indicate that the storage medium is not embodied in a carrier wave or a propagated signal. The term “non-transitory” should not be interpreted that the memory (210) is non-movable. In some examples, the memory (210) is configured to store larger amounts of information. In certain examples, a non-transitory storage medium may store data that can, over time, change (e.g., in Random Access Memory (RAM) or cache).

The processor (220) may include one or a plurality of processors. The one or the plurality of processors may be a general-purpose processor, such as a central processing unit (CPU), an application processor (AP), or the like, a graphics-only processing unit such as a graphics processing unit (GPU), a visual processing unit (VPU), and/or an AI-dedicated processor such as a neural processing unit (NPU). The processor (220) may include multiple cores and is configured to determine the DNN, the S-NSSAI, the PDU session ID, the requested PDU session type, and the UE Integrity Protection Maximum Data Rate included in the PDU session establishment request message stored in the memory (210).

In an embodiment, the communicator (230) includes an electronic circuit specific to a standard that enables wired or wireless communication. The communicator (230) is configured to communicate internally between internal hardware components of the UE (200) and with external devices via one or more networks.

In an embodiment, the PDU session establishment controller (240) includes a transmitter (241), a receiver (242), and a data transfer controller (243).

In an embodiment, the transmitter (241) is configured to send the PDU session establishment request message to the network apparatus (100) to establish the plurality of PDU sessions.

In an embodiment, the receiver (242) is configured to receive the PDU session establishment accept message which includes one of the indication indicating the partial PDU session establishment from the network apparatus (100) and the indication indicating the complete PDU session establishment from the network apparatus (100).

In an embodiment, the data transfer controller (243) is configured to perform one of:
hold transfer of the data to the network apparatus (100) when the UE (200) receives the PDU session establishment accept message including the indication which indicates the partial PDU session establishment, or
configure the plurality of PDU sessions and start transfer of the data to the network apparatus (100) when the UE (200) receives the PDU session establishment accept message including the indication which indicates the complete PDU session establishment.

In an embodiment, the data transfer controller (243) holds the transfer of the data to the network apparatus (100) until all the plurality of PDU sessions are established and initiates a new PDU session establishment request for establishing remaining PDU sessions of the plurality of PDU sessions.

The PDU session establishment controller (240) is implemented by processing circuitry such as logic gates, integrated circuits, microprocessors, microcontrollers, memory circuits, passive electronic components, active electronic components, optical components, hardwired circuits, or the like, and may optionally be driven by firmware. The circuits may, for example, be embodied in one or more semiconductor chips, or on substrate supports such as printed circuit boards and the like.

At least one of the plurality of modules/components of the PDU session establishment controller (240) may be implemented through an AI model. A function associated with the AI model may be performed through the memory (210) and the processor (220). The one or a plurality of processors controls the processing of the input data in accordance with a predefined operating rule or the AI model stored in the non-volatile memory and the volatile memory. The predefined operating rule or artificial intelligence model is provided through training or learning.

Here, being provided through learning means that, by applying a learning process to a plurality of learning data, a predefined operating rule or AI model of a desired characteristic is made. The learning may be performed in a device itself in which AI according to an embodiment is performed, and/or may be implemented through a separate server/system.

The AI model can include a plurality of neural network layers. Each layer has a plurality of weight values and performs a layer operation through calculation of a previous layer and an operation of a plurality of weights. Examples of neural networks include, but are not limited to CNN, DNN, RNN, RBM, DBN, BRDNN, GAN, and deep Q-networks.

The learning process is a method for training a predetermined target device (for example, a robot) using a plurality of learning data to cause, allow, or control the target device to make a determination or prediction. Examples of learning processes include, but are not limited to, supervised learning, unsupervised learning, semi-supervised learning, or reinforcement learning.

Although the FIG. 1 and FIG. 2 show the hardware elements of the network apparatus (100) and the UE (200) but it is to be understood that other embodiments are not limited thereon. In other embodiments, the network apparatus (100) and the UE (200) may include less or more number of elements. Further, the labels or names of the elements are used only for illustrative purpose and does not limit the scope of the invention. One or more components can be combined together to perform same or substantially similar function.

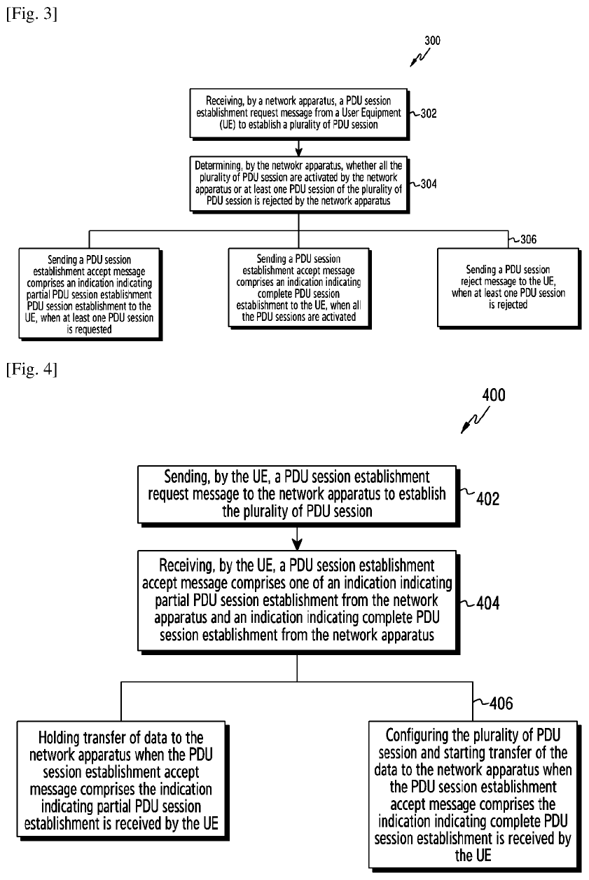

FIG. 3 is a flow chart (300) illustrating a method for handling the PDU session establishment in the wireless network by the network apparatus (100), according to the embodiments as disclosed herein.

Referring to the FIG. 3, at step 302, the method includes the network apparatus (100) receiving the PDU session establishment request message from the UE to establish the plurality of PDU sessions. For example, in the network apparatus (100) as illustrated in the FIG. 1, the PDU session management controller (140) is configured to receive the PDU session establishment request message from the UE to establish the plurality of PDU sessions.

At step 304, the method includes the network apparatus (100) determining whether all the plurality of PDU sessions are activated by the network apparatus or at least one PDU session of the plurality of PDU sessions is rejected by the network apparatus. For example, in the network apparatus (100) as illustrated in the FIG. 1, the PDU session management controller (140) is configured to determine whether all the plurality of PDU sessions are activated by the network apparatus or at least one PDU session of the plurality of PDU sessions is rejected by the network apparatus.

At step 306, the method includes the network apparatus (100) performing one of: sending the PDU session establishment accept message including the indication which indicates the partial PDU session establishment to the UE (200), when at least one PDU session of the plurality of PDU sessions is requested by the network apparatus (100), sending the PDU session establishment accept message including the indication which indicates the complete PDU session establishment to the UE (200), when all the plurality of PDU sessions are activated by the network apparatus (100), and sending the PDU session reject message to the UE (200), when at least one PDU session of the plurality of PDU sessions is rejected by the network apparatus (100).

FIG. 4 is a flow chart (400) illustrating a method for handling the PDU session establishment in the wireless network by the UE (200), according to the embodiments as disclosed herein.

Referring to the FIG. 4, at step 402, the method includes the UE (200) sending the PDU session establishment request message to the network apparatus (100) to establish the plurality of PDU sessions. For example, in the UE (200) as illustrated in the FIG. 2, the PDU session establishment controller (240) is configured to send the PDU session establishment request message to the network apparatus (100) to establish the plurality of PDU sessions.

At step 404, the method includes the UE (200) receiving the PDU session establishment accept message includes one of the indication indicating the partial PDU session establishment from the network apparatus (100) and the indication indicating the complete PDU session establishment from the network apparatus (100).

At step 406, the method includes the UE (200) performing one of: holding transfer of the data to the network apparatus (100) when the PDU session establishment accept message includes the indication indicating the partial PDU session establishment is received by the UE (200), and configuring the plurality of PDU sessions and starting transfer of the data to the network apparatus (100) when the PDU session establishment accept message includes the indication indicating complete PDU session establishment is received by the UE (200).

The various actions, acts, blocks, steps, or the like in the method may be performed in the order presented, in a different order or simultaneously. Further, in some embodiments, some of the actions, acts, blocks, steps, or the like may be omitted, added, modified, skipped, or the like without departing from the scope of the invention.

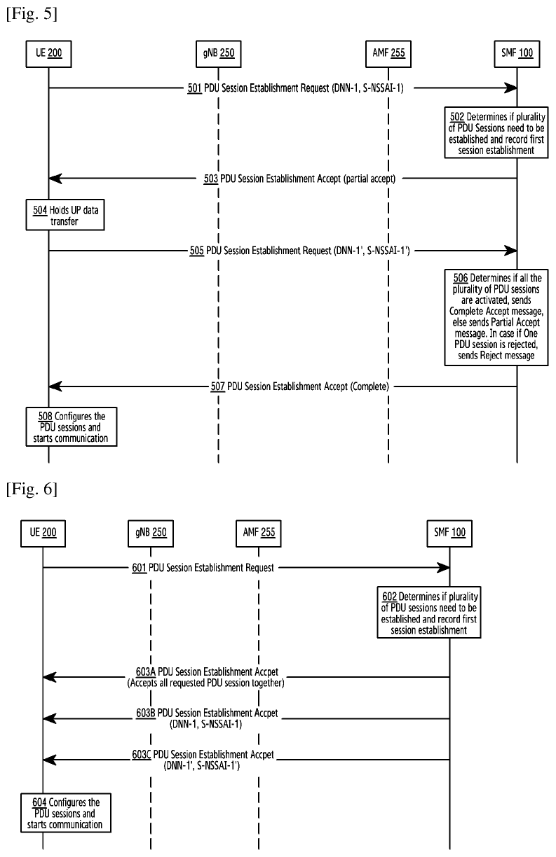

FIG. 5 is an example illustrating a step-by step procedure for handling the PDU session establishment in the wireless network, according to the embodiments as disclosed herein.

Referring to FIG. 5, in order to initiate the PDU session establishment procedure, at step 501, the UE (200) creates a Non-access stratum (NAS) message for example the PDU session establishment request message. When the UE (200) requests to establish a new PDU session, the UE (200) allocates a new PDU session ID which is not currently being used by another PDU session over a Third Generation Partnership Project (3GPP) access or a non-3GPP access. The UE (200) provides the DNN in the NAS message including the PDU session establishment request for the S-NSSAI.

In an embodiment, the UE (200) is configured by the network apparatus (100) to establish the plurality of PDU sessions for the DNN and S-NSSAI. The NAS message includes but not limited to the S-NSSAI, the UE Requested DNN, the PDU session ID, the request type, an old PDU Session ID, the PDU session establishment request, and a port management information container. The PDU session establishment request includes the PDU session ID, the requested PDU session type, the UE integrity protection maximum data rate, a RSN and a PDU session pair ID. In an embodiment, the DNN and the S-NSSAI are associated with the plurality of PDU sessions IDs in order to establish the plurality of PDU sessions per DNN and S-NSSAI.

In an embodiment, an additional attribute indicating the plurality of PDU sessions for the request DNN and S-NSSAI(s) is sent along with the PDU session establishment request along with the plurality of PDU sessions attributes.

In an embodiment, the plurality of PDU sessions attributes include a flag bit to determine a number of PDU sessions or the plurality of PDU sessions to be established per DNN, S-NSSAI based on different security policies.

In an embodiment, when the UE (200) supports the plurality of PDU sessions per DNN and S-NSSAI(s), the UE (200) provides “the plurality of PDU sessions” indication in an initial PDU session establishment message.

At step 502, on receiving the PDU session establishment request, the network apparatus (100) for example the SMF device determines when the plurality of PDU sessions needs to be established and takes a note of the PDU session establishment request for the PDU session establishment.

In an embodiment, the network apparatus (100) determines information about the plurality of PDU sessions from the PDU session attributes, when the PDU session establishment request includes the indication of the plurality of PDU sessions establishment for the request DNN and S-NSSAI.

In an embodiment, the network apparatus (100) determines the information about the plurality of PDU sessions from session management subscription data. When the session management subscription data for corresponding SUPI, DNN and S-NSSAI of a Home Public Land Mobile Network (HPLMN) is not available, then the network apparatus (100) retrieves the session management subscription data from a Unified Data Management (UDM) which indicates the need for the plurality of PDU sessions establishment.

In an embodiment, the network apparatus (100) determines the information about the plurality of PDU sessions based on a local/network/operator's configuration. The local/network/operator's configuration indicates the number of PDU sessions need to be established and security policy for each PDU session for the DNN and the S-NSSAI.

In an embodiment, the network apparatus (100) retrieves and requests to receive update notifications on the session management subscription data from the UDM which includes allowed PDU session types, a default PDU session type, a QoS information per DNN and per S-NSSAI, and a plurality of PDU sessions indication for the DNN and the S-NSSAI with different subscribed UP security policies.

On receiving the PDU session establishment request message via a base station and the AMF device, the network apparatus (100) records the details for example, a PDU session ID and status of the PDU session establishment request in a SM context.

At step 503, on recording the details and the status of the PDU session establishment request for the DNN and the S-NSSAI, the network apparatus (100) sends the PDU session establishment accept message with the indication of partial PDU session accept. This indication suggests that the network apparatus (100) awaits for further and/or a new PDU session establishment request before UP data transfer is initiated for the requested/determined DNN and S-NSSAI(s), as the network apparatus (100) determines not all PDU sessions are established.

At step 504, on receiving the partial accept indication from the network apparatus (100), the UE (200) holds the transfer of UP data until all of the plurality of PDU sessions for the DNN and the S-NSSAI(s) are established and initiates the new PDU session establishment request for establishing remaining of the PDU session(s).

At step 505, the UE (200) sends another PDU session establishment request for the DNN and the S-NSSAI, for example DNN′ and S-NSSAI′ with different PDU session ID.

At step 506, the network apparatus (100) determines when all the PDU sessions for a service/an application/per DNN, S-NSSAI(s) is activated or not.

At step 507, when all the PDU sessions per service are activated, then the network apparatus (100) sends the PDU session establishment accept message with complete indication.

In an embodiment, the flag bit which determines the status of the plurality of the PDU sessions is included in the plurality of the PDU session attributes, where the network apparatus (100) awaits for further PDU session establishment request, when the flag bit is “set”. The network apparatus (100) determines that all of the PDU sessions are established when the flag bit is “reset”. When the network apparatus (100) determines that the flag bit as “reset”, the network apparatus (100) sends the PDU session establishment accept message with complete indication else, the method continues with step 503.

At step 508, on receiving the complete indication, the UE (200) configures all the PDU sessions and starts the UP data transfer securely.

In an embodiment, in steps 501 and 505 as shown in FIG. 5, the DNN and the S-NSSAI settings are as follows: at step 501 DNN-1-Internet and S-NSSAI-1=eMBB, and in step 505 DNN-1′=Internet-Sec and S-NSSAI-1′=eMBB-Sec.

In an embodiment, in step 501 and 505 in addition to DNN=Internet and S-NSSAI=eMBB (may not be as DNN-1 and DNN-1′ respectively), the request type indicates whether the request is for a new PDU session establishment, for the plurality of PDU sessions and for protected or QoS sensitive communication. For example, the request type in step 501 is “Initial request-Multiple PDU-Sec PDU” and in step 505 is the UE requested PDU session establishment procedure. When the request type indicates the request is for the new PDU session establishment, the plurality of PDU sessions and for application specific communication, then the request type is “Initial request-Multiple PDU-App PDU”

In an embodiment, in step 501 and 505 in addition to DNN=Internet and S-NSSAI=eMBB (may not be as DNN-1 and DNN-1′ respectively), the request type indicates the request is for the new PDU session establishment, the plurality of PDU sessions and is for application signaling/control plane communication, for example, in step 501 the request type is “Initial request-Multiple PDU-App CP PDU” and in step 505 the request type is the UE requested PDU session establishment procedure. The request type indicates the request is for the new PDU session establishment, the plurality of PDU sessions and for application specific communication, when the request is “Initial request-Multiple PDU-App UP PDU”

In an embodiment, in step 501 and 505 as shown the FIG. 5, the DNN and the S-NSSAI settings are as follows: DNN=Internet and NSSAI=eMBB type as Sec PDU and App PDU or as App CP PDU and App UP PDU.

In an embodiment, the UE (200) requests for the plurality of PDU sessions establishment, by including the plurality of PDU sessions IDs (also includes the indication that the plurality of PDU sessions needs to be established for the DNN and the S-NSSAI), so that the network apparatus (100) determines the security policy appropriately and establishes the plurality of PDU sessions securely.

In an embodiment, the UE (200) includes PDU session dependence ID(s) in the request, as to include the related PDU session IDs in the UE's context in the network apparatus (100) and to determine the security policy appropriately for each PDU sessions, as to introduce flexibility in selective protection of the traffic belonging to the application. On receiving the request from the UE (200), the network apparatus (100) determines the list of PDU session IDs for a particular application and includes the IDs and the status in the SM context. Once all the PDU sessions are established, the network apparatus (100) provides the complete PDU session accept message to the UE (200) to start the uplink data transfer.

In an embodiment, the AMF device discovers the SMF device which supports the plurality of PDU sessions establishment for the request/determined DNN, S-NSSAI(s) on receiving the UE request in step 501, based on the indication received from the UE (200) for all the PDU sessions of the DNN, S-NSSAI(s) combination for the UE (200).

FIG. 6 is an example illustrating the step-by step procedure for activation of all PDU sessions together or one by one per DNN and S-NSSAI/Distributed Recovery Block (DRB) approach, according to the embodiments as disclosed herein.

Referring to FIG. 6, at step 601, the UE (200) sends the PDU session establishment request for the plurality of PDUs per DNN and S-NSSAI in the NAS message.

In an embodiment, the UE requested PDU session establishment request message includes the request for the plurality of PDU sessions establishment, for example, by including the plurality of DNN and S-NSSAI(s) combinations and/or by including the plurality of PDU sessions IDs (included number of IDs corresponds to number of PDU sessions to be established) and/or the indication on the number of PDU sessions to be established.

At step 602, on receiving the PDU session establishment request, the network apparatus (100) determines when the plurality of PDU sessions needs to be established. Same as described in the FIG. 5, the network apparatus (100) determines information about the plurality of PDU sessions from the PDU session attributes, when the indication of the plurality of PDU sessions establishment per DNN, S-NSSAI(s) combination is included.

In an embodiment, the network apparatus (100) determines information about the plurality of PDU sessions from the session management subscription data. When the session management subscription data for the corresponding SUPI, DNN and S-NSSAI of the HPLMN is not available, then the network apparatus (100) retrieves the session management subscription data from the UDM which indicates the need for the plurality of PDU sessions establishment.

In an embodiment, the network apparatus (100) determines information about the plurality of PDU sessions based on the local/network/operator's configuration. The local/network/operator's configuration indicates the number of PDU sessions need to be established and security policy for each PDU session for the DNN and the S-NSSAI.

At step 603A, the network apparatus (100) sends the PDU session establishment accept message accepting all the requested number of all the PDU sessions.

In an embodiment, the network apparatus (100) accepts the request one by one for each PDU session establishment requested as shown in steps 603B and 603C.

At step 604, on receiving the PDU session establishment accept message accepting all the requested number of all the PDU sessions, the UE (200) configures all the PDU sessions and starts the UP data transfer.

In an embodiment, the UE (200) awaits to receive the new PDU session establishment accept message for each PDUs to be associated with the DNN and the S-NSSAI, when at least one PDU session of the plurality of PDU sessions is not activated.

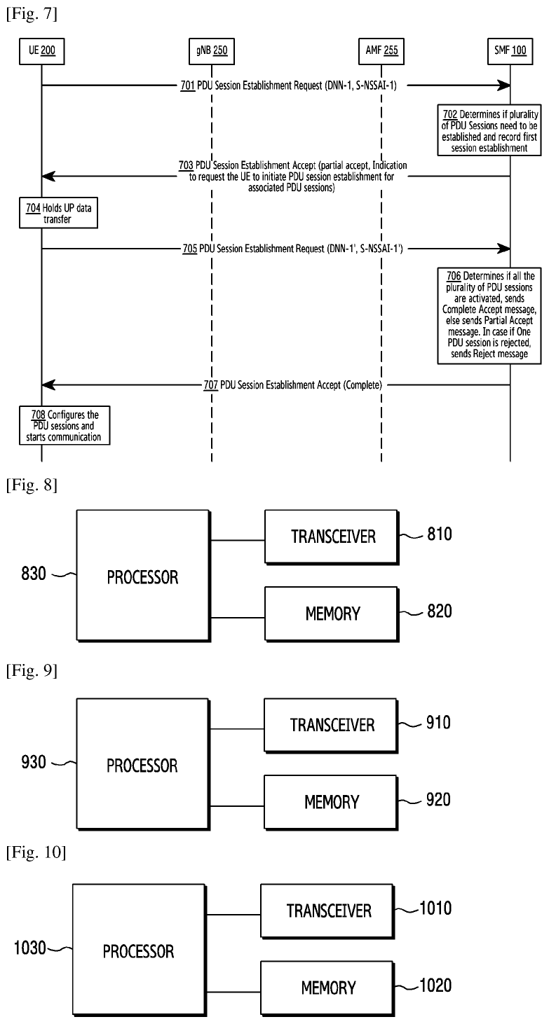

FIG. 7 is an example illustrating a step-by step procedure for determining the need for plurality of PDU sessions establishment and initiating the PDU sessions for other DRBs with different security policies, according to the embodiments as disclosed herein.

Referring to FIG. 7, at step 701, in order to initiate the PDU session establishment procedure, the UE (200) creates the NAS message, for example the PDU session establishment request message. When the UE (200) requests to establish the new PDU session, the UE (200) allocates the PDU session ID which is not currently being used by another PDU session over either the 3GPP access or the non-3GPP access. The UE (200) provides the DNN in the NAS Message containing the PDU session establishment request for the given S-NSSAI.

At step 702, on receiving the PDU session establishment request, the network apparatus (100) determines when the plurality of PDU sessions needs to be established and takes the note of the request for the PDU session establishment.

At step 703, the details and the status of the PDU session establishment for the DNN and the S-NSSAI(s) are recorded. On recording the details and the status of the PDU session establishment for the DNN and the S-NSSAI(s), the network apparatus (100) sends the PDU session establishment accept message with the indication of partial PDU session accept. Additionally in the step 703, the network apparatus (100) indicates the UE (200) to request for the plurality of PDU sessions for the requested/determined DNN, S-NSSAI(s) combination. In this alternative, the UE (200) do not need to determine the need for the plurality of PDU sessions establishment procedure, as the network apparatus (100) indicates to initiate the PDU session establishment procedure.

At step 704, on receiving the partial PDU session accept indication from the network apparatus (100), the UE (200) holds the transfer of UP data until all the PDU sessions for the DNN and the S-NSSAI(s) are established and initiates the new PDU session establishment request for establishing remaining of the PDU session(s).

At step 705, the UE (200) sends the new PDU session establishment request for the DNN and S-NSSAI(s) combination, for example for the DNN′ and S-NSSAI′ combination with different PDU session ID.

At step 706, when all the PDU sessions for the service/the application/per the DNN and the S-NSSAI is activated, the network apparatus (100) sends the PDU session establishment accept message with complete indication.

At step 707, the UE (200) receives the PDU session establishment accept message with complete indication indicating that all the plurality of PDU sessions are established.

At step 708, on receiving the complete indication from the network apparatus (100), the UE (200) configures all the PDU sessions and starts the UP data transfer securely.

In an embodiment, the PDU session IDs for the application is determined by a value of the PDU session ID, so that the network apparatus (100) determines the security policy appropriately and establishes the plurality of PDU sessions. For example, the associated PDU session IDs for the applications are in sequence (either a Least Significant Bit (LSB) value or a Most Significant Bit (MSB) value) as shown in Table 1. The MSB value is used to determine the associated PDU sessions.

TABLE 1
PDU session identity value (octet 1, bit 1 to bit 8)

| Bits | | | | | | | | |
|---|---|---|---|---|---|---|---|---|
| 8 | 7 | 6 | 5 | 4 | 3 | 2 | 1 | |
| 0 | 0 | 0 | 0 | 0 | 0 | 0 | 1 | PDU session identity value 1 (decimal value |
| | | | | | | | | 1, hex 1, oct 1) |
| 0 | 0 | 0 | 1 | 0 | 0 | 0 | 1 | PDU session identity value 2 (associated) |
| | | | | | | | | (decimal value 17, hex 11, oct 21) |
| 0 | 0 | 1 | 0 | 0 | 0 | 0 | 1 | PDU session identity value 3 (associated) |
| | | | | | | | | (decimal value 33, hex 21, oct 41) |

In an embodiment, when the network apparatus (100) determines that the plurality of PDU sessions has to be established, then the network apparatus (100) determines and assigns the security policy from higher level (activation of protection for particular application traffic, for example, activation of protection for application signaling traffic) to lower level (deactivation of protection for particular application traffic, for example, deactivation of protection for application streaming traffic) in sequence for the plurality of PDU sessions for the application. Alternatively, the network apparatus (100) determines and assigns the security policy from the lower level of security to the higher level of protection in sequence for the plurality of PDU sessions for the application, based on the local/network/operator's policy.

In an embodiment, the need for configuration in the network apparatus (100) to provision the UE (200) to initiate the plurality of PDU sessions for the combination of the DNN and the S-NSSAI from security perspective is achieved.

In an embodiment, the need for the network apparatus (100) to ensure that the plurality of PDU sessions are established by the UE (200) for the combination of the DNN and the S-NSSAI, and determine the UP security policy for each PDU sessions is achieved.

In an embodiment, identification of the appropriate PDU session for application packets from the security point of view is achieved by assigning different IP address for each PDU session and by providing appropriate QoS Flow Identifier (QFI) value optionally.

The limit on the number of PDU sessions is overcome by using reserved values and/or bits or by not counting the associated PDU sessions established for limiting the number of PDU sessions, so that restriction in the number of PDU sessions not limits the establishment of the plurality of PDU sessions based on the security requirements.

FIG. 8 illustrates various hardware components of a network entity, according to the embodiments as disclosed herein.

Referring to FIG. 8, the network entity includes a transceiver (810), a memory (820), and a processor (830). The transceiver (810), the memory (820), and the processor (830) of the network entity may operate according to a communication method of the network entity described above. However, the components of the terminal are not limited thereto. For example, the network entity may include fewer or a greater number of components than those described above. However, the components of the network entity are not limited thereto. For example, the network entity may include more or fewer components than those described above. In addition, the processor (830), the transceiver (810), and the memory (820) may be implemented as a single chip. Also, the processor (830) may include at least one processor. Furthermore, the network entity of FIG. 8 corresponds to the network apparatus (100) of the FIG. 1.

The network entity includes at least one entity of a core network. For example, the network entity includes an AMF, a session management function (SMF), a policy control function (PCF), a network repository function (NRF), a user plane function (UPF), a network slicing selection function (NSSF), an authentication server function (AUSF), a UDM and a network exposure function (NEF), but the network entity is not limited thereto.

The transceiver (810) collectively refers to a network entity receiver and a network entity transmitter, and may transmit/receive a signal to/from a base station or a UE. The signal transmitted or received to or from the base station or the UE may include control information and data. In this regard, the transceiver (810) may include an RF transmitter for up-converting and amplifying a frequency of a transmitted signal, and an RF receiver for amplifying low-noise and down-converting a frequency of a received signal. However, this is only an example of the transceiver (810) and components of the transceiver (810) are not limited to the RF transmitter and the RF receiver.

The transceiver (810) may receive and output, to the processor (830), a signal through a wireless channel, and transmit a signal output from the processor (830) through the wireless channel.

The memory (820) may store a program and data required for operations of the network entity. Also, the memory (820) may store control information or data included in a signal obtained by the network entity. The memory (820) may be a storage medium, such as a ROM, a RAM, a hard disk, a CD-ROM, and a DVD, or a combination of storage media.

The processor (830) may control a series of processes such that the network entity operates as described above. For example, the transceiver (810) may receive a data signal including a control signal, and the processor (830) may determine a result of receiving the data signal.

FIG. 9 illustrates a structure of a base station according to an embodiment of the disclosure.

As shown in FIG. 9, the base station according to an embodiment may include a transceiver 910, a memory 920, and a processor 930. The transceiver 910, the memory 920, and the processor 930 of the base station may operate according to a communication method of the base station described above. However, the components of the base station are not limited thereto. For example, the base station may include more or fewer components than those described above. In addition, the processor 930, the transceiver 910, and the memory 920 may be implemented as a single chip.

The transceiver 910 collectively refers to a base station receiver and a base station transmitter, and may transmit/receive a signal to/from a terminal (UE) or a network entity. The signal transmitted or received to or from the terminal or a network entity may include control information and data. The transceiver 910 may include a RF transmitter for up-converting and amplifying a frequency of a transmitted signal, and a RF receiver for amplifying low-noise and down-converting a frequency of a received signal. However, this is only an example of the transceiver 910 and components of the transceiver 910 are not limited to the RF transmitter and the RF receiver.

Also, the transceiver 910 may receive and output, to the processor 930, a signal through a wireless channel, and transmit a signal output from the processor 930 through the wireless channel.

The memory 920 may store a program and data required for operations of the base station. Also, the memory 920 may store control information or data included in a signal obtained by the base station. The memory 920 may be a storage medium, such as read-only memory (ROM), random access memory (RAM), a hard disk, a CD-ROM, and a DVD, or a combination of storage media.

The processor 930 may control a series of processes such that the base station operates as described above. For example, the transceiver 910 may receive a data signal including a control signal transmitted by the terminal, and the processor 930 may determine a result of receiving the control signal and the data signal transmitted by the terminal.

FIG. 10 illustrates a structure of a UE according to an embodiment of the disclosure.

As shown in FIG. 10, the UE according to an embodiment may include a transceiver 1010, a memory 1020, and a processor 1030. The transceiver 1010, the memory 1020, and the processor 1030 of the UE may operate according to a communication method of the UE described above. However, the components of the UE are not limited thereto. For example, the UE may include more or fewer components than those described above. In addition, the processor 1030, the transceiver 1010, and the memory 1020 may be implemented as a single chip. Also, the processor 1030 may include at least one processor. Furthermore, the UE of FIG. 10 corresponds to the UE (200) of the FIG. 2.

The transceiver 1010 collectively refers to a UE receiver and a UE transmitter, and may transmit/receive a signal to/from a base station or a network entity. The signal transmitted or received to or from the base station or a network entity may include control information and data. The transceiver 1010 may include a RF transmitter for up-converting and amplifying a frequency of a transmitted signal, and a RF receiver for amplifying low-noise and down-converting a frequency of a received signal. However, this is only an example of the transceiver 1010 and components of the transceiver 1010 are not limited to the RF transmitter and the RF receiver.

Also, the transceiver 1010 may receive and output, to the processor 1030, a signal through a wireless channel, and transmit a signal output from the processor 1030 through the wireless channel.

The memory 1020 may store a program and data required for operations of the UE. Also, the memory 1020 may store control information or data included in a signal obtained by the UE. The memory 1020 may be a storage medium, such as read-only memory (ROM), random access memory (RAM), a hard disk, a CD-ROM, and a DVD, or a combination of storage media.

The processor 1030 may control a series of processes such that the UE operates as described above. For example, the transceiver 1010 may receive a data signal including a control signal transmitted by the base station or the network entity, and the processor 1030 may determine a result of receiving the control signal and the data signal transmitted by the base station or the network entity.

Those skilled in the art will understand that the various illustrative logical blocks, modules, circuits, and steps described in this application may be implemented as hardware, software, or a combination of both. To clearly illustrate this interchangeability between hardware and software, various illustrative components, blocks, modules, circuits, and steps are generally described above in the form of their functional sets. Whether such function sets are implemented as hardware or software depends on the specific application and the design constraints imposed on the overall system. Technicians may implement the described functional sets in different ways for each specific application, but such design decisions should not be interpreted as causing a departure from the scope of this application.

In the above-described embodiments of the disclosure, all operations and messages may be selectively performed or may be omitted. In addition, the operations in each embodiment do not need to be performed sequentially, and the order of operations may vary. Messages do not need to be transmitted in order, and the transmission order of messages may change. Each operation and transfer of each message can be performed independently.

Although the figures illustrate different examples of user equipment, various changes may be made to the figures. For example, the user equipment can include any number of each component in any suitable arrangement. In general, the figures do not limit the scope of this disclosure to any particular configuration(s). Moreover, while figures illustrate operational environments in which various user equipment features disclosed in this patent document can be used, these features can be used in any other suitable system.

The various illustrative logic blocks, modules, and circuits described in this application may be implemented or performed by a general purpose processor, a Digital Signal Processor (DSP), an Application Specific Integrated Circuit (ASIC), a Field Programmable Gate Array (FPGA) or other programmable logic devices, discrete gates or transistor logics, discrete hardware components, or any combination thereof designed to perform the functions described herein. The general purpose processor may be a microprocessor, but in an alternative, the processor may be any conventional processor, controller, microcontroller, or state machine. The processor may also be implemented as a combination of computing devices, such as a combination of a DSP and a microprocessor, a plurality of microprocessors, one or more microprocessors cooperating with a DSP core, or any other such configuration.

The steps of the method or algorithm described in this application may be embodied directly in hardware, in a software module executed by a processor, or in a combination thereof. The software module may reside in RAM memory, flash memory, ROM memory, EPROM memory, EEPROM memory, register, hard disk, removable disk, or any other form of storage medium known in the art. A storage medium is coupled to a processor to enable the processor to read and write information from/to the storage media. In an alternative, the storage medium may be integrated into the processor. The processor and the storage medium may reside in an ASIC. The ASIC may reside in a user terminal. In an alternative, the processor and the storage medium may reside in the user terminal as discrete components.

In one or more designs, the functions may be implemented in hardware, software, firmware, or any combination thereof. If implemented in software, each function may be stored as one or more pieces of instructions or codes on a computer-readable medium or delivered through it. The computer-readable medium includes both a computer storage medium and a communication medium, the latter including any medium that facilitates the transfer of computer programs from one place to another. The storage medium may be any available medium that can be accessed by a general purpose or special purpose computer.

While the disclosure has been shown and described with reference to various embodiments thereof, it will be understood by those skilled in the art that various changes in form and details may be made therein without departing from the spirit and scope of the disclosure as defined by the appended claims and their equivalents.

1. A method performed by a network apparatus (100) for handling Protocol Data Unit (PDU) session establishment in a wireless network, the method comprising:
receiving a PDU session establishment request message from a User Equipment (UE) (200) to establish a plurality of PDU sessions;
determining whether all the plurality of PDU sessions are activated by the network apparatus (100) or at least one PDU session of the plurality of PDU sessions is rejected by the network apparatus (100); and
performing one of:
sending a PDU session establishment accept message comprises an indication indicating partial PDU session establishment to the UE (200), when at least one PDU session of the plurality of PDU sessions is requested by the network apparatus (100),
sending a PDU session establishment accept message comprises an indication indicating complete PDU session establishment to the UE (200), when all the plurality of PDU sessions are activated by the network apparatus (100), and
sending a PDU session reject message to the UE (200), when the at least one PDU session of the plurality of PDU sessions is rejected by the network apparatus (100).

2. The method of claim 1, wherein the PDU session establishment request message comprises a Single-Network Slice Selection Assistance Information (S-NSSAI), a UE requested Data Network Name (DNN), a Subscriber Permanent Identifier (SUPI), a PDU session Identifier (ID), a request type, and a PDU session establishment request comprising a plurality of PDU sessions attributes.

3. The method of claim 2, wherein the plurality of PDU sessions attributes of the PDU session establishment request comprises at least one of the PDU session ID, a requested PDU session type, a multi-access PDU connectivity service indicating when the at least one PDU session provides multi-access PDU connectivity service or not, and a flag bit to determine number of PDU sessions or the plurality of PDU sessions to be established per DNN and S-NSSAI based on different security policies.

4. The method of claim 1, wherein determining whether all the plurality of PDU sessions are activated by the network apparatus (100) or the at least one PDU session of the plurality of PDU sessions is rejected by the network apparatus (100) comprises:
determining whether the plurality of PDU sessions needs to be established based on the PDU session establishment request message;
determining a PDU session ID and status of the plurality of PDU sessions from one of a plurality of PDU sessions attributes, session management subscription data or based on local/network/operator's configuration indicating number of PDU sessions to be established and security policy for each PDU session of the plurality of PDU sessions, when the plurality of PDU sessions needs to be established;
recording the PDU session ID and the status of the plurality of PDU sessions in a Session Management (SM) context; and
determining whether all the plurality of PDU sessions are activated by the network apparatus (100) or the at least one PDU session is rejected by the network apparatus (100) based on the SM context.

5. A method performed by an user equipment (UE) (200) for handling Protocol Data Unit (PDU) session establishment in a wireless network, the method comprising:
sending a PDU session establishment request message to a network apparatus (100) to establish a plurality of PDU sessions;
receiving a PDU session establishment accept message comprises one of an indication indicating partial PDU session establishment from the network apparatus (100) and an indication indicating complete PDU session establishment from the network apparatus (100); and
performing one of:
holding transfer of data to the network apparatus (100) when the PDU session establishment accept message comprises the indication indicating partial PDU session establishment is received by the UE (200); and
configuring the plurality of PDU sessions and starting transfer of the data to the network apparatus (100) when the PDU session establishment accept message comprises the indication indicating the complete PDU session establishment is received by the UE (200).

6. The method of claim 5, wherein the UE (200) receives the PDU session establishment accept message comprises the indication indicating the partial PDU session establishment when at least one PDU session of the plurality of PDU sessions is requested by the network apparatus (100).

7. The method of claim 5, wherein the UE receives the PDU session establishment accept message comprises the indication indicating the complete PDU session establishment when all the plurality of PDU sessions are activated by the network apparatus (100).

8. The method of claim 5, wherein the UE (200) receives a PDU session reject message from the network apparatus (100), when at least one PDU session of the plurality of PDU sessions is rejected by the network apparatus (100).

9. A network apparatus (100) for handling Protocol Data Unit (PDU) session establishment in a wireless network, the network apparatus (100) comprising:
a memory (110);
a processor (120) coupled with the memory (110);
a communicator (130) coupled with the memory (110) and the processor (120); and
a PDU session management controller (140) coupled with the memory (110), the processor (120) and the communicator (130), and configured to:
receive a PDU session establishment request message from a User Equipment (UE) (200) to establish a plurality of PDU sessions;
determine whether all the plurality of PDU sessions are activated by the network apparatus (100) or at least one PDU session of the plurality of PDU sessions is rejected by the network apparatus (100); and
perform one of:
send a PDU session establishment accept message comprises an indication indicating partial PDU session establishment to the UE (200), when the at least one PDU session of the plurality of PDU sessions is requested by the network apparatus (100);
send a PDU session establishment accept message comprises an indication indicating complete PDU session establishment to the UE (200), when all the plurality of PDU sessions are activated by the network apparatus (100), and
send a PDU session reject message to the UE (200), when the at least one PDU session of the plurality of PDU sessions is rejected by the network apparatus (100).

10. The network apparatus (100) of claim 9, wherein the PDU session establishment request message comprises a Single-Network Slice Selection Assistance Information (S-NSSAI), a UE requested Data Network Name (DNN), a Subscriber Permanent Identifier (SUPI), a PDU session Identifier (ID), a request type, and a PDU session establishment request comprising a plurality of PDU sessions attributes.

11. The network apparatus (100) of claim 10, wherein the plurality of PDU sessions attributes of the PDU session establishment request comprises at least one of the PDU session ID, a requested PDU session type, a multi-access PDU connectivity service indicating when the at least one PDU session provides multi-access PDU connectivity service or not, and a flag bit to determine number of PDU sessions or the plurality of PDU sessions to be established per DNN and S-NSSAI based on different security policies.

12. The network apparatus (100) of claim 9, wherein the determining whether all the plurality of PDU sessions are activated by the network apparatus (100) or at least one PDU session of the plurality of PDU sessions is rejected by the network apparatus (100) comprises:
determine whether the plurality of PDU sessions needs to be established based on the PDU session establishment request message by the network apparatus (100);
determine a PDU session ID and status of the plurality of PDU sessions from one of a plurality of PDU sessions attributes, session management subscription data or based on local/network/operator's configuration indicating number of PDU sessions to be established and security policy for each PDU session of the plurality of PDU sessions, when the plurality of PDU sessions needs to be established by the network apparatus (100);
record the PDU session ID and the status of the plurality of PDU sessions in a Session Management (SM) context by the network apparatus (100); and
determine whether all the plurality of PDU sessions are activated by the network apparatus (100) or the at least one PDU session is rejected by the network apparatus (100) based on the SM context by the network apparatus (100).

13. An user equipment (UE) (200) for handling Protocol Data Unit (PDU) session establishment in a wireless network, the UE (200) comprising:
a memory (210);
a processor (220) coupled with the memory (210);
a communicator (230) coupled with the memory (210) and the processor (220); and
a PDU session establishment controller (240) coupled with the memory (210), the processor (220) and the communicator (230), and configured to:
send a PDU session establishment request message to a network apparatus (100) to establish a plurality of PDU sessions;
receive a PDU session establishment accept message comprises one of an indication indicating partial PDU session establishment from the network apparatus (100) and an indication indicating complete PDU session establishment from the network apparatus (100); and
perform one of:
hold transfer of data to the network apparatus (100) when the PDU session establishment accept message comprises the indication indicating partial PDU session establishment is received by the UE (200); and
configure the plurality of PDU sessions and start transfer of the data to the network apparatus (100) when the PDU session establishment accept message comprises the indication indicating complete PDU session establishment is received by the UE (200).

14. The UE (200) of claim 13, wherein the PDU session establishment request message comprises a Single-Network Slice Selection Assistance Information (S-NSSAI), a UE requested Data Network Name (DNN), a Subscriber Permanent Identifier (SUPI), a PDU session Identifier (ID), a request type, and a PDU session establishment request comprising a plurality of PDU sessions attributes.

15. The UE (200) of claim 14, wherein the plurality of PDU sessions attributes of the PDU session establishment request comprises at least one of the PDU session ID, a requested PDU session type, a multi-access PDU connectivity service indicating when the at least one PDU session provides multi-access PDU connectivity service or not, and a flag bit to determine number of PDU sessions or the plurality of PDU sessions to be established per DNN and S-NSSAI based on different security policies.
